(19) United States
(12) Patent Application Publication
(10) Pub. No.: US 2007/0089724 A1
(43) Pub. Date: Apr. 26, 2007

(54) Foldable barbecue grill

(75) Inventor: William Home, Taipei (TW)

Correspondence Address: LEONG C LEI, PMB # 1008, 1867 YGNACIO VALLEY ROAD, WALNUT CREEK, CA, 94598, US

(73) Assignee: GRAND HALL ENTERPRISE CO., LTD.

(21) Appl. No.: 11/257,989

(22) Filed: Oct. 26, 2005

(51) Int. Cl. A47J 37/07

(52) U.S. Cl. 126/9 R

(57) ABSTRACT

A foldable barbecue grill is provided herein. The barbecue grill mainly contains a bottom shelf with wheels, a pair of side racks, diagonal brackets, and a barbecue stove. The legs of the side racks are hinged to the four corners of the bottom shelf. Foldable diagonal brackets are configured between the bottom shelf and the legs of the side racks. A number of locking members are configured between the barbecue stove and the side racks to join them together. By releasing the locking members, the barbecue stove could be separated from the side racks. Then, the diagonal brackets are disengaged so that the side racks are retracted and rest on the bottom shelf Then, the separated barbecue stove could be placed on top of the folded side racks so that the entire barbecue grill, with its significantly reduced height, could be easily stored for later use.

### BACKGROUND OF THE INVENTION

(a) Technical Field of the Invention

The present invention generally relates to barbecue grills, and more particularly to a barbecue grill whose bottom shelf could be folded for space saving and easy storage.

(b) Description of the Prior Art

Barbecue has been one of the most popular outdoor activities for people of all ages. Barbecue grills have therefore undergone a lot changes, always aiming at providing more convenience for people's usage.

Currently, most of the barbecue grills are of some rigid form, usually with wheels for easy moving and usually with a certain height so that a user doesn't need to bend his or her back when operating the grill. However, these conveniences are at the cost of storage space and transportation convenience. Even though some foldable grills have been disclosed, their folded forms are usually irregular with less flat surfaces. It is usually difficult to stack the folded grill with other stuff in a limited space.

### SUMMARY OF THE INVENTION

The primary purpose of the present invention is to provide a foldable barbecue grill which can be easily folded and stored.

The barbecue grill according to the present invention mainly contains a bottom shelf with wheels, a pair of side racks, diagonal brackets, and a barbecue stove. The legs of the side racks are hinged to the four corners of the bottom shelf Foldable diagonal brackets are configured between the bottom shelf and the legs of the side racks. A number of locking members are configured between the barbecue stove and the side racks to join them together. By releasing the locking members, the barbecue stove could be separated from the side racks. Then, the diagonal brackets are disengaged so that the side racks are retracted and rest on the bottom shelf Then, the separated barbecue stove could be placed on top of the folded side racks so that the entire barbecue grill, with its significantly reduced height, could be easily stored in a limited space or inside the trunk of a car. This is the major objective of the present invention.

The bottom shelf and the side racks of the barbecue grill are all in rectangular shapes and, when the side racks are folded, the bottom shelf and the side racks together become a platform with a flat top. The barbecue grill is therefore easy to be stacked with other stuff in a confined and crowded space. This is another objective of the present invention.

Further more, the back, left, and right sides of the barbecue stove are hinged with wind shields so that, when the barbecue grill is not in use, the wind shields could be folded and rest on top of the barbecue stove to prevent dusts to accumulate in the barbecue stove.

The barbecue stove also has two side tables hinged to the left and right sides of the barbecue stove. After the wind shields are folded, the side tables could be flipped toward each other to cover the barbecue stove and form a flat top on the barbecue stove. Other stuff therefore could be reliably stacked upon the barbecue stove in a confined storage space. This is yet another objective of the present invention.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the barbecue grill according to an embodiment of the present invention when it is in operation.

FIG. 2 is a perspective view of the barbecue grill of FIG. 1 when the barbecue stove is separated.

FIG. 3 shows how the diagonal brackets of FIG. 1 are disengaged to fold the side racks of the bottom shelf.

FIG. 4 is a perspective view of the bottom shelf and its side racks of FIG. 1 when they are folded.

FIG. 5 is a perspective view of the barbecue grill of FIG. 1 when it is completely folded for storage.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

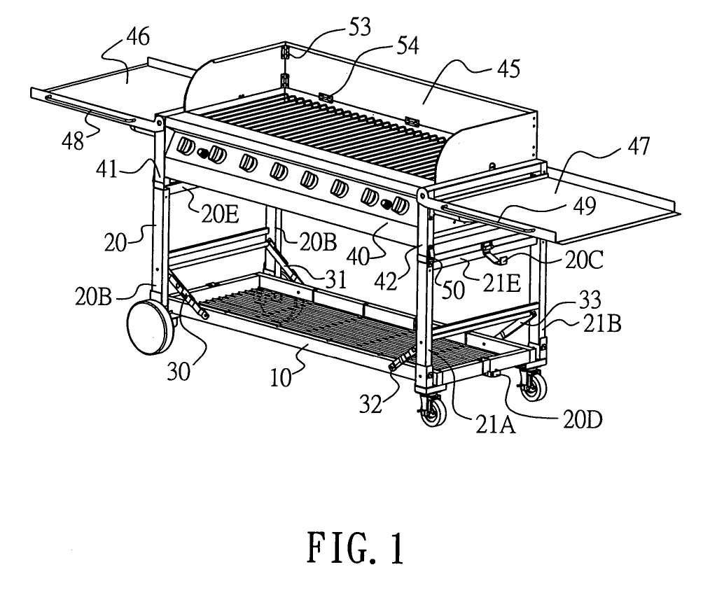

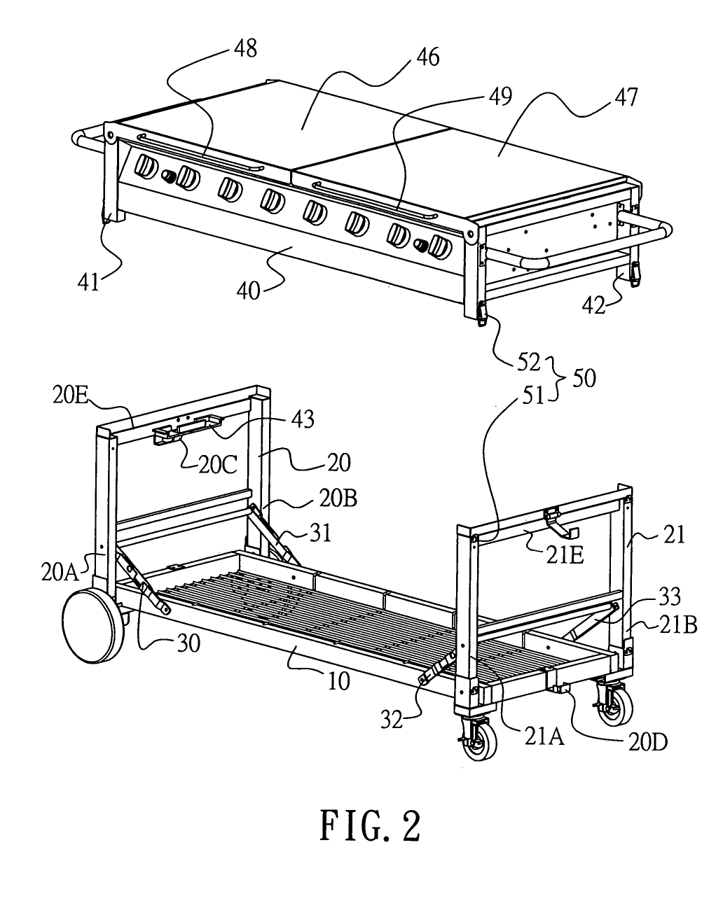

FIG. 1 is a perspective view showing the appearance of the barbecue grill according to an embodiment of the present invention when it is in operation, while FIG. 2 shows the barbecue grill when the barbecue stove is separated. As illustrated, the present embodiment mainly contains a bottom shelf 10 with two or more wheels (not numbered), side racks 20 and 21, diagonal brackets 30, 31, 32, 33, and a barbecue stove 40. Each of the side racks 20 and 21 has two legs 20A, 20B, and 21A and 21B, respectively. The four legs 20A, 20B, 21A, and 21B, are hinged to the four corners of the bottom shelf 10 so that the side racks 20 and 21 are facing toward each other at the left and right side of a user standing in front of the barbecue grill. Foldable diagonal brackets 30, 31, 32, are 33 are configured between the front and back rims of the bottom shelf 10 and the four legs 20A, 20B, 21A, 21B. Additionally, there could be hooks 20C and 20D configured on the side racks 20 and 21 respectively, facing outward for hanging the gas or fuel tank (not shown). To support the barbecue stove 40, two supporting members 43 are configured on the top beams 20E and 21E of the side racks 20 and 21, facing inward and toward each other.

The barbecue stove 40 is configured between a pair of side racks 41 and 42, corresponding to the side racks 20 and 21 respectively. Around the cooking grid (not numbered) of the barbecue stove 40, three wind shields 45 are configured at the back, left, and right sides of the barbecue stove 40. The wind shields 45 could be hinged to the barbecue stove 40 with hinges 54 or with each other with hinges 53 so that, when the barbecue stove 40 is not in use, the wind shields 45 could be folded down on the cooking grid to prevent dusts to accumulate in the barbecue stove 40. Two side tables 46 and 47 are hinged to the side racks 41 and 42 respectively, which have handles 48 and 49 configured along their front rims facing toward the user.

To join the side racks 41 and 42 to the side racks 20 and 21, four locking members 50 are configured therebetween. Each of the locking members 50 contains a buckle 52 and a hook 51. The buckles 52 are all located at the bottom of the four legs of the side racks 41 and 42, and the hooks 51 are all located at the top of the four legs of the side racks 20 and 21.

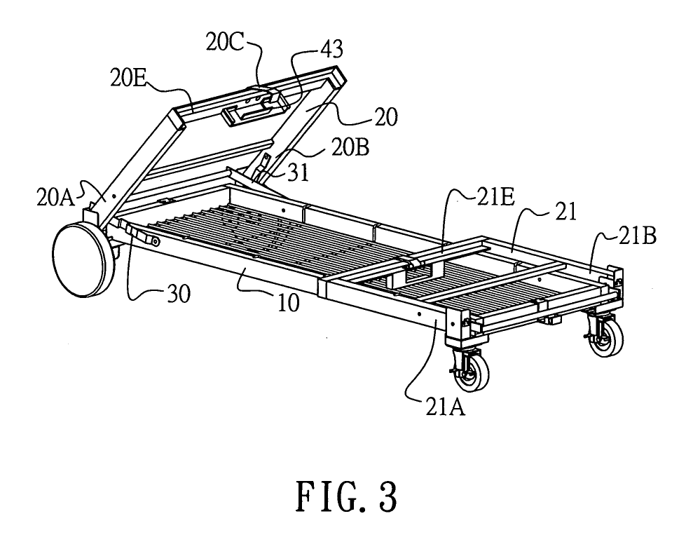

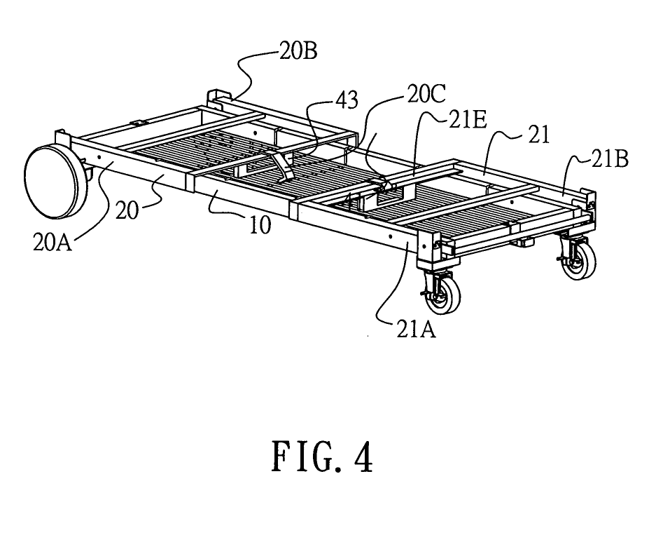

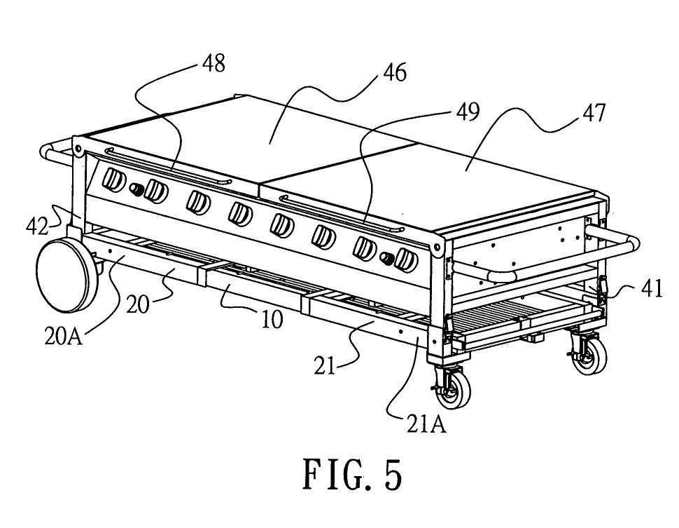

After barbecue, the windshields 45 could be folded down on the cooking grid and the user could flip the side tables 46 and 47 inward via the handles 48 and 49 to cover the barbecue stove 40. The side tables 46 and 47 therefore form a flat top on the barbecue stove 40. Then, after releasing the locking members 50, the barbecue stove 40 along with its side racks 41 and 42 could be separated from the side racks 20 and 21, as shown in FIG. 2. Then, as shown in FIG. 3, the diagonal brackets 30, 31, 32, and 33 are disengaged so that the side racks 20 and 21 are retracted and rest on the bottom shelf 10, as shown in FIG. 4. As the bottom shelf 10 and side racks 20 and 21 are all in rectangular shapes, when the side racks 20 and 21 are folded, the bottom shelf 10 and the side racks 20 and 21 jointly become a platform with a flat top. Then, as shown in FIG. 5, the separated barbecue stove 40 and the side racks 41 and 42 could be placed on top of the folded side racks 20 and 21 so that the entire barbecue grill, with its significantly reduced height, could be easily stored in a limited space or inside the trunk of a car. With the flat surface provided by the folded side tables 46 and 47, the barbecue grill therefore could be reliably and easily stacked with other stuff in a confined and crowded space.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A foldable barbecue grill comprising a bottom shelf with a plurality of wheels, a pair of side racks, a plurality of diagonal brackets, and a barbecue stove; wherein
the legs of said side racks are hinged to the corners of said bottom shelf; said diagonal brackets are configured between the legs of said side racks and the rims of said bottom shelf; a plurality of supporting members are configured on top of said side racks to support said barbecue stove; and a plurality of locking members are configured between said barbecue stove and said side racks to fix said barbecue and said side racks together.

2. The foldable barbecue grill according to claim 1, wherein each of said locking members comprises a buckle and a hook; said buckle is configured at an appropriate location at the bottom of said barbecue stove; and said hook is configured at an appropriate location at the top of said side racks.

3. The foldable barbecue grill according to claim 1, further comprising a plurality of wind shields installed at and connected to the back, left, and right sides of said barbecue stove with hinges.

4. The foldable barbecue grill according to claim 1, further comprising two side tables hinged to the left and right sides of said barbecue stove respectively.

5. The foldable barbecue grill according to claim 4, wherein each of said side tables is configured with a handle along the front rim of said side table.
